(19) United States
(12) Patent Application Publication
(10) Pub. No.: US 2014/0100142 A1
(43) Pub. Date: Apr. 10, 2014

(54) TRACEABLE POLYMERIC SCALE INHIBITORS AND METHODS OF USING SUCH SCALE INHIBITORS

(71) Applicant: MEADWESTVACO CORPORATION, Richmond, VA (US)

(72) Inventor: Kimberley MacEwan, Mount Pleasant, SC (US)

(73) Assignee: MEADWESTVACO CORPORATION, Richmond, VA (US)

(21) Appl. No.: 13/646,357

(22) Filed: Oct. 5, 2012

(51) Int. Cl. C08G 63/692; C09K 8/52; C02F 5/14

(52) U.S. Cl. 507/219; 528/365; 252/180

(57) ABSTRACT

A traceable polymeric scale inhibitor comprises a traceable phosphinate moiety and a scale inhibiting moiety including carboxylate functionality. The polymeric scale inhibitor may be derived from polymerization of a mixture comprising a phosphinate compound and a vinyl-carboxylate monomer. The traceable polymeric scale inhibitor may be used for oilfield applications. A method of reducing scale formation comprises treating the fluid subjected to scale formation with the traceable polymeric scale inhibitor. The method provides a means to determine when additional treatment of scale inhibitors is needed, which conduit or wellbore needs additional treatment of scale inhibitor, and how much additional scale inhibitor is needed in the repeat treatment to provide effective inhibition of scale formation.

### FIELD OF THE INVENTION

Embodiments of the present disclosure relate to traceable polymeric scale inhibitors and to methods of using such inhibitors for reducing scale formation.

### BACKGROUND OF THE DISCLOSURE

The precipitation of inorganic salts, such as calcium carbonate, calcium sulfate, barium sulfate or strontium sulfate, from aqueous fluids to form scale is a persistent and common problem encountered in oilfield operations to recover hydrocarbons from subterranean formations. Water flooding is the most widely used technique to recover oil from oil-bearing subterranean formations. The technique involves injecting water into the formation to drive oil therein toward a production system composed of one or more wells through which the oil is recovered. The injection water may be produced water or seawater. Seawater, which is readily available in offshore operations, is typically used for the injection water in the water flooding operation. Seawater contains large amounts of dissolved salts such as sulfate. Therefore, sulfate scales are formed when seawater is mixed with formation water. The carbonate scales are primarily generated in the near wellbore/wellbore region due to the pressure drop. Carbon dioxide is frequently introduced into the formations during enhanced oil recovery operations, resulting in absorption of carbon dioxide into aqueous fluids. As aqueous fluids enter the wellbore during production, a reduction in pressure causes the absorbed carbon dioxide to flash out of the aqueous fluids to gas phase. This increases the pH of aqueous fluids and causes growth of carbonate scales in the near wellbore/wellbore region. Furthermore, water encountered in oilfield operations contains low solubility salts. Under certain conditions, these sparingly soluble salts may precipitate out of water resulting in scale formation on various surfaces of the oil recovery system such as walls of pipework, heat exchanger surfaces, valves, and vessels. The scale can block the perforations in the casing, production tubing, downhole pumps and the formation in either the production well or injection wells. Additionally, scale can block the near wellbore region matrix permeability and micro fissures.

Scale formation affects heat transfer, interferes with fluid flow, facilitates corrosion and harbors bacteria. In oilfield piping and tubing, scale can cause restriction to flow and high friction loss. Furthermore, the oil production rate declines steadily as the scale forms. To restore the oil production rate, various methods have been used.

The formations may be re-perforated by opening new perforations through the well casings and exposing new formation surfaces. This method may be used to temporarily restore the oil production rate, but it is subject to further plugging by additional scale formation. Furthermore, this method can be relatively expensive and is therefore of limited value for the formation where rapid scale deposition occurs.

The scale deposited in subterranean formations or production equipment and tubing may be removed mechanically or chemically, both of which are costly and time-consuming. The wellbore must be shut-in during cleaning operations. For chemical removal methods, chemical agents are repeatedly injected into the affected formations, equipment or tubing to dissolve the scale. The chemical removal methods may be acid treatments, base treatments, two stage treatments (bases followed by acids), or chelating treatments such as using EDTA (ethylendiaminetetraacetic acid) as a chelant. For mechanical removal methods, scale may be removed using various mechanical devices such as impact or cavitation jets.

Preventative methods for inhibiting the growth and deposition of scale have been considered as a more preferred approach to the problem of scale formation. The most common classes of scale inhibitors are inorganic phosphates, organophosphorus compounds and organic polymers. Two of the principle inorganic phosphates are sodium tripolyphosphate and hexametaphosphate. Organophosphorus compounds are phosphonic acid and phosphate ester salts. The organic polymers used are generally low molecular weight polyacrylic acid salts or modified polyacrylamides and copolymers thereof.

Mineral scale formation occurs via nucleation and subsequent crystal growth stages. Scale inhibitors may prevent or retard scale formation by several mechanisms, such as nucleation inhibition, crystal poison and dispersion. All scale inhibitors take part in both nucleation inhibition and crystal poison mechanisms, but one mechanism may predominant the other. Polymeric scale inhibitors, for example, mainly operate as a nucleation inhibitor, while phosphonate scale inhibitors operate mainly as growth modifiers. In addition, scale inhibitors should efficiently inhibit scale formation in oilfield environments characterized by high temperature, low pH and high concentrations of divalent and trivalent metal ions (i.e., high ionic strength).

Scale inhibitors have been used to prevent scale formation during oilfield production by adding to the flood water during water injection and to topside production systems. Additionally, scale inhibitors have been used for treating scaling problems which often occur at the well bottom or as the production fluids progress up the production well. One method of getting scale inhibitor into these oilfield fluids is by the so-called “squeeze” operation. In the squeeze application, the oilfield production is halted while the scale inhibitor is injected into the subterranean formations. The wellbore is shut in for a suitable period and then returned to production. During the shut-in period, the scale inhibitor is attached to the formation matrix by adsorption or by temperature-activated precipitation. When the wellbore is put back into production, the scale inhibitor releases out of the formation into the aqueous fluids at sufficiently high concentrations to prevent scale deposits from forming or adhering to the various surfaces both downhole and on the surface.

The scale inhibitor sufficiently controls the scale formation only when its concentration in the fluids is above or equal to its Minimum Inhibitor Concentration (MIC). During oil production, the concentration of scale inhibitor in the oilfield fluids will diminish over time until such time that the concentration of scale inhibitor is at about or below the MIC level. Once the concentration of scale inhibitor falls below the MIC level, the scale inhibitor can no longer effectively prevent scale formation. Additional scale inhibitor must be added to maintain the concentration of scale inhibitor in the fluids above the MIC level. Therefore, it is desirable to know the concentration of scale inhibitor in the oilfield fluids and properly determine when and how much additional scale inhibitor must be added into the oilfield fluids to effectively prevent scale formation. It has been difficult to determine when and how much additional scale inhibitor is needed, and which conduit or wellbore requires additional scale inhibitor because the amount of scale inhibitor in the oilfield fluids is very low, generally in parts per million (ppm) levels. To address this difficulty, scale inhibitor has been tagged or labeled so that it may be readily detected.

European Patent Application No. 157465 A1, published on Sep. 10, 1985, to Bevaloid Limited, discloses polymer compositions for water treatment having activated groups attached to the polymer chain backbone by carbon-carbon bonds. The activated groups are subjected to color forming reaction with diazonium aromatic compounds, thereby enabling the polymer compositions to be detected at very low concentration in water.

U.S. Pat. No. 7,943,058, issued on May 17, 2011 to Rhodia Operations, discloses scale inhibitors incorporating certain marking atoms such as phosphorous, boron, silicon, geranium and the like so that the concentration of scale inhibitors may be determined by inductively coupled plasma (ICP) analysis for the marking atoms.

U.S. Patent Publication No. 2012/0032093 A1, published on Feb. 9, 2012 to Kemira Chemicals Incorporation, discloses scale inhibitor compositions including a scale inhibiting moiety and a traceable imidazole moiety. The imidazole moiety provides fluorescence at a wavelength of about 424 nm, and therefore its concentration may be determined using fluorescence spectroscopy technique.

### SUMMARY OF THE DISCLOSURE

In some embodiments, a traceable polymeric scale inhibitor includes a scale inhibiting moiety and a traceable phosphinate moiety, wherein the scale inhibiting moiety comprises carboxylate functionality.

In other embodiments, a method of reducing scale formation includes treating fluids subjected to scale formation with a traceable polymeric scale inhibitor, wherein the traceable polymeric scale inhibitor comprises a scale inhibiting moiety and a traceable phosphinate moiety, the scale inhibiting moiety comprising carboxylate functionality. In one particular embodiment, a method of reducing scale formation in oilfield operations includes adding the traceable polymeric scale inhibitor to the oilfield fluids such as produced water or injection water during secondary recovery process. In another particular embodiment, a method of reducing scale formation in oilfield operations includes squeeze applying such traceable polymeric scale inhibitor to the subterranean formations.

Certain embodiments relate to a method of maintaining a desired amount of a traceable polymeric scale inhibitor in an aqueous fluid system to effectively reduce scale formation. The method comprises adding the traceable polymeric scale inhibitor to the aqueous fluid system, the traceable polymeric scale inhibitor comprising a traceable phosphinate moiety and a scale inhibiting moiety comprising carboxylate functionality; determining a concentration of the traceable phosphinate moiety in the aqueous fluid system; converting the concentration of the traceable phosphinate moiety to a concentration of the traceable polymeric scale inhibitor in the aqueous fluid system; adjusting the concentration of the traceable polymeric scale inhibitor according to what the desired concentration is for the traceable polymeric scale inhibitor in the aqueous fluid system.

### BRIEF DESCRIPTION OF THE DRAWINGS

FIG. 1 shows the comparative NACE calcium sulfate dynamic scale loop (DSL) test results of the traceable polymeric scale inhibitor of Examples 1 and the conventional polyacrylate scale inhibitor (PCA); and

FIG. 2 is a graph plotting the concentration of traceable phosphinate moiety as determined by Palintest Organophosphonate titration method as a function of the concentration of traceable polymeric scale inhibitor.

### DESCRIPTION OF THE DISCLOSURE

The present disclosure now will be described more fully hereinafter, but not all embodiments of the disclosure are shown. While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof.

In a particular embodiment, the traceable polymeric scale inhibitor may comprise a scale inhibiting moiety including carboxylate functionality, and a traceable phosphinate moiety. It is understood that the traceable moiety may also prevent scale formation. Furthermore, the scale inhibiting moiety may be detectable.

In some embodiments, the traceable polymeric scale inhibitor may be prepared from a mixture comprising: a monocarboxylate monomer, a dicarboxylate monomer, and a phosphinate compound selected from the group consisting of hypophosphite, inorganic phosphinate salts, organic phosphinate salt, and combinations thereof.

The term “monocarboxylate monomer” includes a compound represented by structure (I):

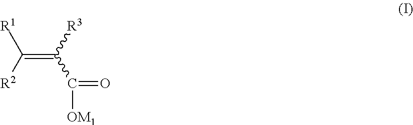

wherein R¹, R² and R³ are independently hydrogen, alkyl group containing up to 7 carbon atoms, or hydroxyl groups; and M₁ is selected from the group consisting of hydrogen, an alkali metal, an alkaline earth metal, ammonium, and NR₁R₂R₃R₄ where R₁, R₂, R₃ and R₄ are independently hydrogen, an alkyl group having from 1 to 7 carbon atoms, or alkoxyl group having from 1 to 7 carbons.

The monocarboxylate monomers represented by structure (I) may include, but are not limited to, carboxylic acid monomers such as acrylic acid, oligomeric acrylic acid, methacrylic acid, crotonic acid, vinylacetic acid and the water-soluble salts thereof.

The term “dicarboxylate monomer” includes a compound represented by structure (II) or (III):

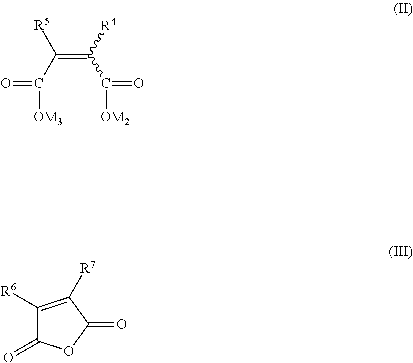

wherein R⁴, R⁵, R⁶ and R⁷ are independently hydrogen, alkyl group containing up to 7 carbon atoms, or hydroxyl group; M₂ and M₃ are independently selected from the group consisting of hydrogen, an alkali metal, an alkaline earth metal, ammonium, and NR₁R₂R₃R₄ where R₁, R₂, R₃ and R₄ are independently hydrogen, an alkyl group having from 1 to 7 carbon atoms, or alkoxyl group having from 1 to 7 carbons.

Non-limiting examples of the dicarboxylate monomers represented by structure (II) or (III) may include, unsaturated dicarboxylic acid monomers such as unsaturated dicarboxylic acid monomers containing 4-10 carbon atoms per molecule and anhydrides of the cis-dicarboxylic acids; or unsaturated monomer containing more than two carboxylic acid groups such as polyacid. Non-limiting examples of unsaturated dicarboxylic acid monomers may be maleic acid; maleic anhydride; fumaric acid; itaconic acid; citraconic acid; mesaconic acid; cyclohexenedicarboxylic acid; cis-1,2,3,6-tetrahydrophthalic anhydride; 3,6-epoxy-1,2,3,6-tetrahydrophthalic anhydride; and water-soluble salts thereof.

Phosphinate compounds may be represented by structure (IV):

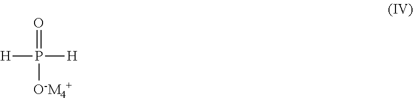

wherein M₄ is selected from the group consisting of hydrogen, an alkali metal, an alkaline earth metal, ammonium, and NR₁R₂R₃R₄ where R₁, R₂, R₃ and R₄ are independently hydrogen, an alkyl group having from 1 to 7 carbon atoms, or alkoxyl group having from 1 to 7 carbons.

Various phosphinate compounds with the represented structure may be used including, but are not limited to, hypophosphite, inorganic phosphinate salts, organic phosphinate salt, or combinations thereof.

In one embodiment, the traceable polymeric scale inhibitor may comprise structure (V):

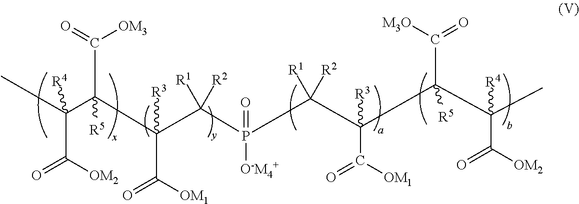

wherein R¹, R², R³, R⁴ and R⁵ are independently hydrogen, alkyl group containing up to 7 carbon atoms, hydroxyl group, or NR₁R₂R₃ where R₁, R₂, R₃ are independently hydrogen, an alkyl group having from 1 to 7 carbon atoms, or alkoxyl group having from 1 to 7 carbons; M₁, M₂, M₃ and M₄ are independently selected from the group consisting of hydrogen, an alkali metal, an alkaline earth metal, ammonium, and NR₁R₂R₃R₄ where R₁, R₂, R₃ and R₄ are independently hydrogen, an alkyl group having from 1 to 7 carbon atoms, or alkoxyl group having from 1 to 7 carbons; x and y are independently integral numbers; a sum of x plus y is greater than 2; and a and b are independently integral numbers; a sum of a plus b is greater than 2.

In one embodiment, the traceable polymeric scale inhibitor may comprise the polymer prepared from acrylic acid, fumaric acid and phosphinate salt by a polymerization process, as shown in formula (VI):

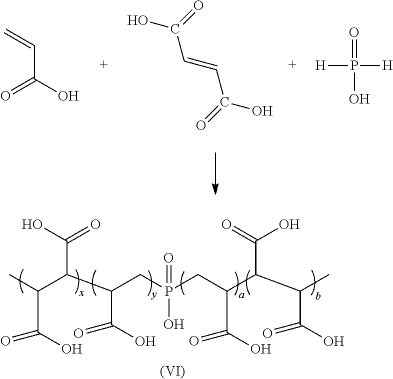

The traceable polymeric scale inhibitor may be produced by any suitable polymerization process. Those skilled in the art are familiar with various polymerization processes. The proportion of the chemicals (e.g. monomers, initiators, chain transferring agents, etc.) employed in the polymerization may be varied to a considerable extent, depending upon the particular polymeric composition and the molecular weight of the polymers desired.

The polymerization may be carried out in a presence of polymerization initiator including, but not limited to: persulfate initiators, such as ammonium persulfate, sodium persulfate and potassium persulfate; azo initiators, such as azoisobutyronitrile (AIBN); organic or inorganic peroxides, such as hydrogen peroxide, t-butyl hydroperoxide, lauryl peroxide, benzoyl peroxide, dicumyl peroxide, acetyl peroxide, caprylyl peroxide, di-tertbutyl peroxide, diisopropyl percarbonate and dicyclohexyl percarbonate; peracid, such as perchlorates; peresters; percarbonates; cerium ammonium nitrate; and the like. The amount of polymerization initiators may be from about 0.01% to about 20% weight based on the total weight of the monomers. After the desired reaction time, the polymerization may be terminated with or without an addition of chain transferring agent such as methylether hydroquinone or a free radical scavenger such as ascorbic acid. The desired reaction time may vary with reaction temperature, initiator concentration, and degree of polymerization desired.

The traceable phosphinate moiety may be present in the traceable polymeric scale inhibitor at an amount of less than 20% weight based on total weight of the traceable polymeric scale inhibitor. In one embodiment, the phosphinate moiety may be from about 0.01% to about 20% weight based on total weight of the polymeric scale inhibitor. In one embodiment, the phosphinate moiety may be from about 0.1% to about 2% weight based on total weight of the traceable polymeric scale inhibitor.

The traceable polymeric scale inhibitor may have a number averaged molecular weight (Mn) from about 1000 Daltons to about 15000 Daltons, as determined by gel permeable chromatography. In some embodiments, the traceable polymeric scale inhibitor may have Mn molecular weight from about 3500-10000 Daltons.

The traceable polymeric scale inhibitors may exhibit at least comparable ability to prevent scale formation as the conventional polyacrylic scale inhibitor (PCA). In some embodiments, the traceable polymeric scale inhibitors may show superior ability in preventing scale formation to the conventional polyacrylic scale inhibitor (PCA).

An effective amount of the traceable scale inhibitor against scale formation may vary based on various factors including, but are not limited to, the particular system to be treated, the scale inhibiting moieties, the area subjected to scale deposition, water quantity, pH, temperature, or concentration of the scale forming species. In some embodiments, an effective amount of the traceable scale inhibitor (i.e., MIC concentration) may be less than 50 ppm. In some embodiments, the effective amount may be from about 5 ppm to about 25 ppm. In some embodiments, the effective amount may be from about 7 ppm to about 15 ppm.

In a particular embodiment, a method of reducing scale formation may comprise treating fluids subjected to scale formation with a traceable polymeric scale inhibitor, the polymeric scale inhibitor comprising a traceable phosphinate moiety and a scale inhibiting moiety or moieties including carboxylate functionality.

Prior to using the traceable scale inhibitor at a field site, experiments may be conducted in a laboratory to determine an effective minimum inhibitor concentration (MIC) of the traceable scale inhibitor. Any known technique may be used to determine the MIC concentration of the traceable polymeric sale inhibitor. For example, as shown in the Experimental section described herein, the MIC concentration of the traceable polymeric sale inhibitor may be measured using a dynamic scale loop (DSL) test. At the field site, the operators may quickly determine an amount of the traceable scale inhibitor in the tested fluids. By comparing the detected amount of traceable scale inhibitor in the tested fluids with the MIC value of the traceable scale inhibitor, the operators may readily decide when it is most suitable to apply additional scale inhibitor, and at which rate and amount the additional scale inhibitor should be added into the fluids.

In a particular embodiment, a method of reducing scale formation may comprise adding a traceable polymeric scale inhibitor to the fluids subjected to scale formation, the traceable polymeric scale inhibitor comprising a traceable phosphinate moiety and a scale inhibiting moiety including carboxylate functionality; measuring an amount of the traceable polymeric scale inhibitor in the fluids; and further adding the traceable polymeric scale inhibitor to the fluids when the measured amount of traceable polymeric scale inhibitor is approaching a minimum inhibition concentration (MIC) of the traceable polymeric scale inhibitor. The traceable scale inhibitor may be added directly into the fluid system to be treated in a fixed quantity, or may be provided as an aqueous solution and added periodically, continually, or continuously to the fluid system as desired.

In some embodiments, a method of reducing scale formation in oilfield applications may comprise adding a traceable polymeric scale inhibitor to oilfield fluids, the traceable polymeric scale inhibitor comprising a traceable phosphinate moiety and a scale inhibiting moiety including carboxylate functionality; measuring an amount of the traceable polymeric scale inhibitor in the oilfield fluids; and further adding the traceable polymeric scale inhibitor to the oilfield fluids when the measured amount of traceable polymeric scale inhibitor is approaching a minimum inhibition concentration (MIC) of the traceable polymeric scale inhibitor.

The traceable polymeric scale inhibitor may be added to the oilfield fluids such as produced water or injection water during secondary recovery processor periodically, continually or continuously. Furthermore, the traceable polymeric scale inhibitor may be added by squeeze applying to the subterranean formations. Additionally, the traceable scale inhibitors may be applied by other techniques commonly used offshore including, but not limited to, gas-lift injection, downhole annulus injection, encapsulation or soluble matrix techniques, sub-sea wellhead injection, or secondary topside treatment.

The amount of traceable polymeric scale inhibitor in the oilfield fluids may be measured periodically, continually or continuously. Any quantitative technique suitable for determining the amount of traceable polymeric scale inhibitor may be used including, but not limited to, visually titrating the traceable polymeric scale inhibitor with a color-forming agent that provides a distinguish and reliable end point, or titrating the traceable polymeric scale inhibitor with a color-forming agent using colorimeter to determine an end point. In one embodiment, the amount of traceable polymeric scale inhibitor may be determined using Palintest Organophosphonate titration method, as in the Experimental section described herein.

In a particular embodiment, a method of maintaining a desired amount of a traceable polymeric scale inhibitor in an aqueous fluid system may comprise: adding the traceable polymeric scale inhibitor to the aqueous fluid system, the traceable polymeric scale inhibitor comprising a traceable phosphinate moiety and a scale inhibiting moiety including carboxylate functionality; determining an amount of the traceable phosphinate moiety in the aqueous fluid system; converting the amount of traceable phosphinate moiety to an amount of the traceable polymeric scale inhibitor in the aqueous fluid system; and adjusting the amount of the traceable polymeric scale inhibitor according to what the desired concentration is for the traceable polymeric scale inhibitor in the aqueous fluid system.

The traceable polymeric scale inhibitor may be added to the aqueous fluid present in the subterranean formations, in surface or subsurface tubing in fluid communication therewith.

In one embodiment, the traceable polymeric scale inhibitor may be added into the subterranean formations by squeeze treatment. The squeeze treatment may consist of four steps: pre-injection, addition of the scale inhibitor (typically in an amount of less than 100,000 ppm), over flush, and then shut in wherein the wellbore is shut in for a suitable period before being returned to production. During the shut-in period, the traceable scale inhibitor may be adsorbed into the formation matrix. As the production resumes, the scale inhibitor is desorbed over a period of time into the aqueous fluids to prevent scale formation. Samples of the oilfield fluids may be taken periodically, continually or continuously to determine the amount of traceable phosphinate moiety in the fluids and consequently the amount of the traceable polymeric scale inhibitor. Then, an additional aqueous solution of the scale inhibitors may be injected (“re-squeezed”) into the formations such that the amount of traceable polymeric scale inhibitor is maintained above the MIC level.

In one embodiment, the traceable polymeric scale inhibitor may be added into water injection and/or water production. Samples of the produced and/or formation fluids may be taken periodically, continually or continuously to determine the amount of traceable phosphinate moiety in the fluids and consequently the amount of traceable polymeric scale inhibitor. Then, an additional aqueous solution of the scale inhibitor may be added into the fluids at the amount needed to maintain the concentration of scale inhibitor above MIC level.

The traceable polymeric scale inhibitors may exhibit desirable scale reduction properties with respect to calcite, barite and other scales under harsh oilfield production conditions (i.e., high temperature, high ionic strength and low pH environments). Breakdowns, maintenance, cleaning and repairs caused or necessitated by scale formation may be minimized when the traceable polymeric scale inhibitor is used.

The traceable polymeric scale inhibitor may effectively reduce scale formation at a lower MIC level than those of known polymeric scale inhibitors. For example, in the squeeze treatment, the concentration of traceable polymeric scale inhibitor may be dropped to lower levels before a repeat squeeze treatment must be performed, thereby extending the squeeze lifetime beyond that available with known scale inhibitors.

Moreover, the traceable polymeric scale inhibitor may provide a quick, simple, and reliable means to evaluate when additional treatment of scale inhibitors is needed, which conduit or wellbore needs additional treatment of scale inhibitor, and how much additional scale inhibitor is needed in the repeat treatment to provide effective inhibition of scale formation. For example, the traceable phosphinate moiety may be detected quantitatively by Palintest Organophosphonate titration method as in the Experimental section described herein, which may be simple, quick, and reliable for oilfield applications.

In addition to oilfield applications, the traceable scale inhibitor may be used as scale inhibitor in any industrial water system where scale inhibition is needed. Examples of such industrial water systems may include, but are not limited to, cooling tower water systems; boiler water systems; hot water heaters; heat exchangers; mineral process waters; paper mill water systems; black liquor evaporators in the pulp industry; desalination systems; cleaning system; pipelines; gas scrubber systems; continuous casting processes in the metallurgical industry; air conditioning and refrigeration systems; industrial and petroleum process water; water reclamation and purification systems; membrane filtration water systems; food processing streams; and waste treatment systems.

The traceable polymeric scale inhibitor may be used in combination with other water treatment agents, if other agents are compatible with the traceable scale inhibitor and do not cause precipitations of the traceable scale inhibitor. Non-limiting examples of other water treatment agents may include, but are not limited to, viscosification agents; surfactants such as anionic surfactants, non-ionic surfactants and cationic surfactants; sequestrates; chelating agents; corrosion inhibitors; hydrate inhibitors; anti-agglomeration agents; asphaltene inhibitors wax inhibitors; biocides; bleaches; demulsifiers; foam controlling agents; oxygen scavengers; sulfide scavengers; pH controlling and/or buffering agents; chromium salts; zinc salts; dispersants; coagulants; or combinations thereof.

In the squeeze treatment application, the traceable polymeric scale inhibitor may be used in conjunction with spearhead chemicals, surfactants and/or emulsifiers. These chemicals may be applied prior to the squeeze treatment of the traceable polymeric scale inhibitor to aid adsorption onto the rock and to minimize emulsification problems. In a normal “squeeze” treatment, it may be difficult to control the concentration of the scale inhibitor returning in produced brines. The inhibitor may be produced quickly initially, with its concentrations tailing off with time to ineffective amounts. Spearhead chemicals, surfactants and/or emulsifiers, or pH adjustment have been used to control or delay the return time of the scale inhibitor (i.e., increase squeeze lifetime).

### EXPERIMENTS

To determine the scale inhibition efficiency and traceable ability of the traceable polymeric scale inhibitor, various traceable maleic acid/acrylic acid/phosphinate (MAAP) polymeric samples with different monomer molar ratio (MA/AA) and molecular weights (i.e., Examples 1-5 and 7), along with a traceable fumaric acid/acrylic acid/phosphinate (FAAP) polymeric sample (i.e., Example 8), were synthesized and tested. Additionally, a conventional copolymer (MAA, without traceable phosphinate moiety) of maleic acid and acrylic acid monomers (i.e., Example 6) was synthesized and tested to provide comparative scale inhibition efficiency to the traceable polymeric scale inhibitors.

TABLE 1 shows some physical properties of the traceable polymeric scale inhibitors (Examples 1-5 and 7-8) and the polymeric scale inhibitor without traceable moiety (Example 6). The number-average molecular weight (Mn) and polydispersity index (PDI) of polymeric samples were determined using a gel permeation chromatography available from Waters Corporation having four aqueous columns set up in series: Waters ultra hydrogel one 11530, one 11525 and two 11520, and equipped with a differential refractive index detector, Waters 410 RI. Each sample was diluted with mobile phase to a concentration of 0.1 mg/ml, and a 1000 μl of the solution was injected onto a gel permeation chromatography in 4.79 M acetonitrile (pH of 11.0) at room temperature.

TABLE 1

| | Monomer | | | | | |
|---|---|---|---|---|---|---|
| | Molar | pH (1% | Viscosity, | % | | |
| Example | Ratio | solution) | cP @ 25° C. | solids | Mn | PDI |
| #1 MAAP | 7.50:1 | 2.64 | 7.60 | 30 | 2600 | 1.64 |
| #2 MAAP | 7.50:1 | 2.71 | 3.57 | 30 | 1500 | 1.46 |
| #3 MAAP | 7.50:1 | 2.56 | 20.6 | 30 | 3200 | 1.79 |
| #4 MAAP | 7.50:1 | 2.60 | 29.6 | 30 | 5000 | 1.64 |
| #5 MAA | 7.50:1 | 2.73 | 6.50 | 30 | 2600 | 1.64 |
| #6 MAAP | 1:1 | 2.90 | 8.60 | 30 | 2400 | 1.88 |
| #7 FAAP | 17.2:1 | 3.60 | 27.0 | 30 | 3500 | 1.76 |

Determination of Scale Inhibition Efficiency Against Calcium Carbonate

The polymeric samples of Examples 1-7 and a conventional polyacrylate scale inhibitor (PCA) were tested for calcium ion tolerance (i.e., chelating ability with calcium ion) using a method slightly modified from that disclosed in U.S. Pat. No. 4,590,014.

The precipitation of calcium carbonate was determined on a visual basis using the following procedure: a known mass of tested polymer sample (1.00 g) was added to a beaker, diluted with water to the 100 ml. The resulting solution was stirred and the pH was adjusted to 8 using a 50% sodium hydroxide (NaOH) solution. Then 10 ml of a 2% sodium carbonate (Na₂CO₃) solution was added via volumetric pipette. The pH was adjusted to 11 with a 50% NaOH solution. The mixture was then titrated with 0.25 N calcium acetate solution by adding about 0.5 ml at a time, while the pH was monitored continuously via pH probe. Between additions of calcium acetate, the pH was adjusted to 11 using a 10% NaOH solution. The additions of 0.5 ml calcium acetate and pH adjustment were repeated until an end point was reached, wherein a clear solution maintained a haze for 1 minute. The following formula was used to calculate an amount of calcium carbonate chelated per gram of polymer:

$$Ca C {O}_{3} required per gram of polymer = \frac{( ml of {Ca ( O Ac )}_{2} ) ( 25 )}{( dry wt . of polymer in grams )}$$

TABLE 2 shows the comparative abilities of the tested polymers to chelate calcium ion and prevent precipitation of calcium carbonate. The traceable polymeric scale inhibitors containing traceable phosphinate moiety of Examples 1-4 and 6-7 showed comparable abilities to chelate calcium ions as the MAA polymer of Example 5 containing no traceable phosphinate moiety. Therefore, incorporation of traceable phosphinate moiety did not negatively impact the calcium chelating ability. Furthermore, as shown in Examples 1-4, the efficiency of the calcium ion chelating increased as the molecular weight of the traceable polymer increased.

As shown in TABLE 2, the traceable scale inhibitors of Examples 1-4 and 6-7 were at least 1.5 times more effective than the conventional polyacrylate scale inhibitor (PCA) in inhibiting the precipitation of calcium carbonate from the solution.

TABLE 2

| | Monomer | | CaCO₃ Required for End Point (mg) |
|---|---|---|---|
| Example | Molar Ratio | Mn | per 1 g of Polymeric Example |
| #1 MAAP | 7.50:1 | 2600 | 542 |
| #2 MAAP | 7.50:1 | 1500 | 417 |
| #3 MAAP | 7.50:1 | 3200 | 875 |
| #4 MAAP | 7.50:1 | 5000 | 917 |
| #5 MAA | 7.50:1 | 2600 | 500 |
| #6 MAAP | 1:1 | 2400 | 417 |
| #7 FAAP | 17.2:1 | 3500 | 667 |
| PCA | | 2400 | 292 |

Determination of Scale Inhibition Efficiency Against Strontium Sulfate and Barium Sulfate

The NACE Standard TM0197-91 (Laboratory Screening Test to Determine the Ability of Scale Inhibitors to Prevent the Precipitation of Barium Sulfate and/or Strontium Sulfate from Solution for Oil and Gas Production Systems), also known as “the NACE static bottle test,” was used to test the polymeric samples for their scale inhibition efficiencies against strontium and barium sulfate.

The tests were performed at a temperature of 71° C., pH of 5.5 and 24 hour residence time. TABLE 3 showed the compositions of strontium sulfate brine and barium sulfate brine used for the tests (in mg/L).

TABLE 3

| | |
|---|---|
| NACE strontium | NACE barium |
| sulfate brine | sulfate brine |

| | Strontium | Sulfate | Barium | Sulfate |
|---|---|---|---|---|
| Ion | brine | brine | brine | brine |
| Sodium | 301 | 230 | 150 | 150 |
| Barium | 0 | 0 | 343 | 0 |
| Strontium | 440 | 0 | 0 | 0 |
| Sulfate | 0 | 480 | 0 | 240 |
| Chloride | 820 | 0 | 409 | 0 |
| TDS* | 1561 | 710 | 1805 | 710 |

*TDS = Total Dissolved Solids

The traceable scale inhibitors of Examples 1, 2 and 6, and the conventional polyacrylate scale inhibitor (PCA) were subjected to the NACE static bottle tests to determine their efficiencies in inhibiting the precipitation of barium and strontium sulfate scale from the solution.

The percentage inhibition was calculated using the following relationship:

$$\% inhibition = ( \frac{{C}_{a} - {C}_{b}}{{C}_{c} - {C}_{b}} ) \times 100$$

where Cₐ is the concentrations of barium ions (Ba²⁺) or strontium ions (Sr²⁺) in the tested sample after precipitation, C_{b} is the concentrations of barium ions (Ba²⁺) or strontium ions (Sr²⁺) in the blank after precipitation, G is the concentrations of barium ions (Ba²⁺) or strontium ions (Sr²⁺) in the blank before precipitation.

TABLE 4 showed the comparative percentage inhibitor efficiencies of the traceable scale inhibitor of Examples 1, 2 and 6 and of the conventional scale inhibitor PCA against barium sulfate and strontium sulfate scale.

TABLE 4

| | % Inhibition for | % Inhibition for |
|---|---|---|
| Sample | Barium Sulfate* | Strontium Sulfate** |
| Example 1 | 18.1 | 97.6 |
| Example 2 | 27.9 | 94.3 |
| Example 7 | 3.5 | 94.3 |
| PCA | 0.0 | 94.6 |

*The test was performed at the concentration of scale inhibitor of 16.7 ppm (5 ppm based on the dry weight of tested polymer).
**The test was performed at the concentration of scale inhibitor of 3.33 ppm (1 ppm based on the dry weight of tested polymer).

The traceable scale inhibitors of Examples 1, 2, 6 showed comparable efficiencies in inhibiting the precipitation of strontium sulfate scale as the conventional scale inhibitor PCA.

TABLE 4 further showed that the traceable scale inhibitors of Examples 1, 2, 6 exhibited far superior efficiencies in inhibiting the precipitation of barium sulfate scale compared to the conventional scale inhibitor PCA.

Determination of Scale Inhibition Efficiency Against Calcium Sulfate

The brines stated in NACE Standard TM0374-2007 (Laboratory Screening Test to Determine the Ability of Scale Inhibitors to Prevent the Precipitation of Calcium Sulfate and Calcium Carbonate from Solution for Oil and Gas Production Systems), were used in dynamic scale loop (DSL) or tube blocking test to determine the scale inhibition efficiency of the traceable scale inhibitor of Example 1 and the conventional scale inhibitor PCA against calcium sulfate scale.

TABLE 5 showed the compositions of calcium brine and sulfate brine used for the DSL tests (in mg/L).

TABLE 5

| Ion | Calcium Brine | Sulfate Brine |
|---|---|---|
| Sodium | 2952 | 6401 |
| Calcium | 3021 | 0 |
| Sulfate | 0 | 7209 |
| Chloride | 9903 | 4550 |
| TDS* | 15876 | 18160 |

*TDS = Total Dissolved Solids

The tests were performed at a temperature of 55° C. and a pressure of 0 psi using an automatic dynamic scale loop system model PMAC DSL-V4 available from Process Measurement and Control (PMAC) Systems, Ltd equipped with an oven commercially available from Memmert GmbH & Co. KG. The test coil was a one meter stainless steel tube with an inner diameter of 0.76 mm. The flow rate through the test coil was 4 mL/min. The calcium sulfate scale occurred when a change in differential pressure across the test coil of 5 psi was observed.

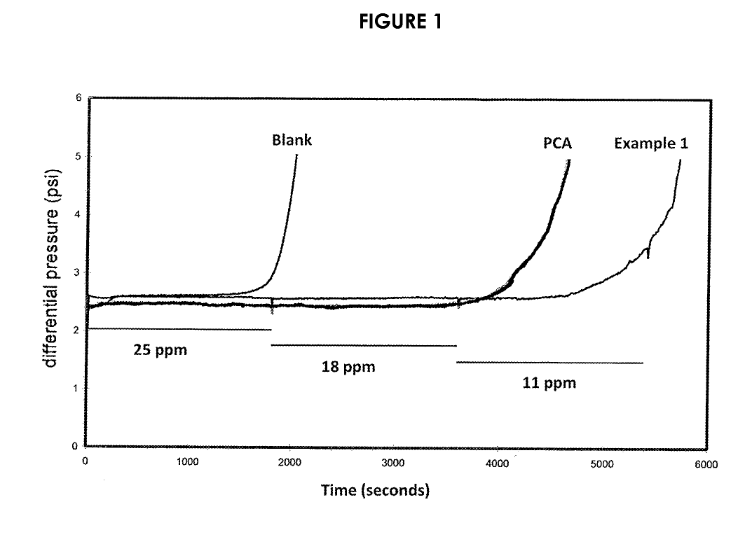

FIG. 1 shows the differential pressures across the test coil as a function of time. The DSL tests were performed for a blank sample (i.e., without any scale inhibitor), the conventional scale inhibitor PCA, and the traceable scale inhibitor of Example 1.

As shown in FIG. 1, the traceable scale inhibitor of Example 1 was more efficient in inhibiting the precipitation of calcium sulfate scale than the conventional scale inhibitor PCA.

Determination of Minimum Inhibitor Concentrations (MIC)

The minimum inhibitor concentration (MIC) of the traceable scale inhibitor of Example 1 and the conventional scale inhibitor PCA were determined using the dynamic scale loop (DSL) test as described in the determination of scale inhibition efficiency against calcium sulfate.

The traceable scale inhibitor of Example 1 and the conventional scale inhibitor PCA each were subjected to the DSL test. Scale rate was identified by measuring the change in pressure differential across the test coil over either 30 or 20 minutes, depending on scaling time required for the blank. A maximum scale rate occurred when no inhibitor was added to the solution. The minimum inhibitor concentration (MIC) was defined as an amount of inhibitor required to keep the differential pressure from reaching 5 psi.

TABLE 6 showed the MIC concentrations of the traceable scale inhibitor of Example 1 and the conventional scale inhibitor PCA.

TABLE 6

| | Minimum Inhibitor Concentration |
|---|---|
| Sample | MIC (ppm) |
| Traceable Scale Inhibitor | 12 ppm |
| of Example 1 | (3.6 ppm dry polymer wt.) |
| PCA (Conventional Scale Inhibitor) | 17 ppm |
| | (5.1 ppm dry polymer wt.) |

The traceable scale inhibitor of Example 1 had a lower MIC concentration than the conventional scale inhibitor PCA. The calcium sulfate scale occurred when the concentration of Example 1 was less than 12 ppm, while the calcium sulfate scale took place when the concentration of PCA was less than 17 ppm.

Determination of Traceable Efficiency

The traceable efficiency of the traceable scale inhibitor was determined by a micro titration technique based on Palintest Organophosphonate test using Palintest Direct-Reading Titration, Palintest Organophosphonate No 1 Tablet (i.e., indicator tablet), and Palintest Organophosphonate No 2 Solution (i.e., standard thorium nitrate solution), available from Palintest USA.

The tested traceable scale inhibitor of known concentration was dissolved in 10 ml of water. To a 10 ml of the traceable scale inhibitor solution, one indicator tablet was added, crushed and mixed to dissolve in the solution to produce a solution having green color. The indicator tablet contained a screened xylenol orange indicator together with a buffer mixture which provided the correct conditions for the test. Furthermore, the indicator tablet eliminated the tedious pH correction procedure and ensured an improved green to purple end point color change. A standard thorium nitrate solution in a graduated syringe was added one drop at a time to the tested green solution containing traceable scale inhibitor and indicator, while the tested solution was shaking to ensure an adequate mixing. The standard thorium nitrate solution was added until the end point was reached, which was when the color of the tested solution changed from green to purple. The amount of thorium nitrate solution used corresponded to the amount of traceable phosphinate moiety present in the tested solution in ppm.

Before the end point, thorium in the standard thorium nitrate solution formed a complex with the traceable phosphinate moiety in the tested solution. The thorium-phosphinate complex was colorless; therefore, there was no change in color of the tested solution. At the end point, the amount of thorium was equal to the amount of traceable phosphinate moiety. After the end point, thorium formed a complex with the indicator in the tested solution, resulting in a purple solution. The thorium-indicator complex occurred only when thorium had formed complex with all phosphinate moiety present in the tested solution.

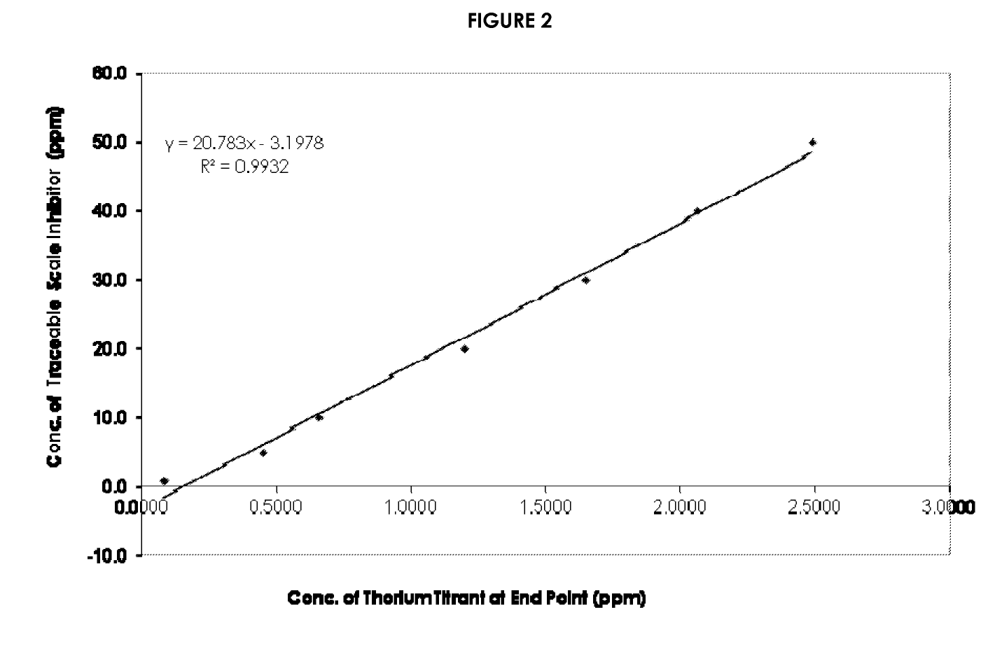

The amounts of standard thorium nitrate solution at the end point of Palintest Organophosphonate titration was used to determine the amounts of traceable phosphinate scale inhibitor present in the tested solution. A linear relationship between the concentration of standard thorium nitrate solution used at the end point and the concentrations of traceable phosphinate scale inhibitor in the tested solution was as shown in FIG. 2 and the following formula:

Conc. of Traceable Scale Inhibitor=[20.9×ppm of Thorium Titrant added*]−3.37

*ppm of thorium titrant added is indicated on the graduated syringe, included with the test kit, at the end of the titration.

Therefore, the amount of traceable polymeric scale inhibitor in the tested solution (e.g., oilfield liquid) may be determined simply and quickly by visually titrating the tested solution using Palintest Organo-phosphonate test and then correlating the concentration of standard thorium solution at end point to the traceable scale inhibitor. The traceable phosphinate moiety in the tested solution is detectable to levels as low as 0.50 ppm based on a dried polymer weight using the Palintest Organophosphonate test described herein.

### Syntheses of the Polymeric Samples

### Example 1

Into a round bottomed flask equipped with two dropping funnels, reflux condenser, nitrogen inlet, temperature probe, and stirrer, there were charged 245.8 g deionized water and 0.78 g (0.0089 moles) sodium hypophosphite. While introducing nitrogen into the flask, the temperature was increased to 80° C. Then, 178 g of an aqueous solution of 52% acrylic acid (AA) and 11% maleic anhydride (MA) (a net content of acrylic acid of 93.0 g which is 1.29 moles, and a molar ratio of MA/AA of 7.5) and a 34.6% sodium persulfate solution were added simultaneously dropwise through separate dropping funnels over 1.5 hours. The molar ratio of the monomers and sodium hypophosphite is 162:1. The addition rates of the two vessels were: persulfate solution at 2.04 ml/min and MA/AA at 1.89 ml/min. After addition of the reactants was completed, the solution was aged for 1 hour at 80° C. and then was left standing for cooling to room temperature. Once cooled, 50% sodium hydroxide solution was added to provide a sodium salt of maleic acid/acrylic acid/phosphinate (MAAP) copolymer at 30% solids, pH of 2.64 and number average molecular weight of 2600.

### Example 2

A copolymer phosphinate was prepared by the method described in Example 1, except that a 35.2% sodium persulfate solution was added to the reaction mixture at a rate of 4.64 ml/min. The sodium salt of maleic acid/acrylic acid/phosphinate (MAAP) was obtained having 30% solids, pH of 2.71 and a number average molecular weight of 1500.

### Example 3

A copolymer phosphinate was prepared by the method described in Example 1, except that a 16.9% sodium persulfate solution was added to the reaction mixture at a rate of 0.95 ml/min. The sodium salt of maleic acid/acrylic acid/phosphinate (MAAP) was obtained having 30% solids, pH of 2.56 and a number average molecular weight of 3200.

### Example 4

A copolymer phosphinate was prepared by the method described in Example 1, except that a 15.0% sodium persulfate solution was added to the reaction mixture at a rate of 1.09 ml/min. The sodium salt of maleic acid/acrylic acid/phosphinate (MAAP) was obtained having 30% solids, pH of 2.62 and a number average molecular weight of 5000.

### Example 5

A comparative example was prepared by the method described in Example 1, without the addition of the sodium hypophosphite. A 34.9% sodium persulfate solution as added to the reaction mixture at a rate of 2.18 ml/min. The sodium salt of maleic acid/acrylic acid/phosphinate (MAA) was obtained having 30% solids, pH of 2.73 and a number average molecular weight of 2600.

### Example 6

Into a round bottomed reaction flask equipped with two dropping funnels, reflux condenser, nitrogen inlet, temperature probe, and stirrer, there were charged 78.93 g deionized water, 49.63 g (0.51 moles) maleic anhydride and 0.76 g (0.009 moles) sodium hypophosphite. The pH of the resulting solution was adjusted to 4.21 with 42.50 g (0.53 moles) 50% sodium hydroxide solution. While introducing nitrogen into the flask, the temperature was increased to 80° C. Then, 47.83 g of an aqueous solution of 80% acrylic acid (a net content of acrylic acid was 38.03 g, which is 0.53 moles, and the molar ratio of MA/AA charged was 1), and 301.59 g of a 33.1% sodium persulfate solution were added separately and simultaneously dropwise through separate dropping funnels over 2.0 hours. The addition rates of the two vessels were: persulfate solution at 2.51 ml/min and acrylic acid at 0.30 ml/min. After addition of the reactants was completed, the solution was aged for 1 hour at 80° C. and then was left standing for cooling to room temperature. A sodium salt of maleic acid/acrylic acid/phosphinate (MAAP) copolymer was obtained having 30% solids, pH of 2.90 and number average molecular weight of 2400.

### Example 7

Into a round bottomed reaction flask equipped with two dropping funnels, reflux condenser, nitrogen inlet, temperature probe, and stirrer, there were charged 103.1 g deionized water and 0.76 g (0.0086 moles) sodium hypophosphite. While introducing nitrogen into the flask, the temperature was increased to 80° C. Then, 186.9 g of an aqueous solution of 48% acrylic acid (AA) and 7% disodium fumarate (FA) (net content of acrylic acid was 90.6 g, which is 1.26 moles, and the molar ratio of FA/AA charged was 14.9), and 166.7 g of a 25.6% sodium persulfate solution were added simultaneously dropwise through separate dropping funnels over 1.5 hours. The addition rates of the two vessels were: persulfate solution at 1.85 ml/min and FA/AA at 2.08 ml/min. After addition of the reactants was completed, the solution was aged for 1 hour at 80° C. and then was left standing for cooling to room temperature. A sodium salt of disodium fumarate/acrylic acid/phosphinate (FAAP) copolymer was obtained having 30% solids, pH of 3.60 and number average molecular weight of 3500.

While the disclosure has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

1. A traceable polymeric scale inhibitor comprising a scale inhibiting moiety and a traceable phosphinate moiety, the scale inhibiting moiety comprising carboxylate functionality.

2. The traceable polymeric scale inhibitor of claim 1 derived from a mixture comprising:
a phosphinate compound selected from the group consisting of hypophosphite, inorganic hypophinate salts, organic hypophinate salts, and combinations thereof;
a monocarboxylate monomer includes a compound represented by structure (I): 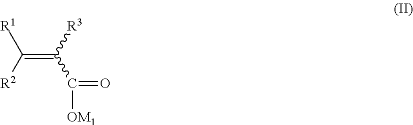
wherein R¹, R² and R³ are independently hydrogen, alkyl group containing up to 7 carbon atoms, or hydroxyl group; and M₁ is selected from the group consisting of hydrogen, an alkali metal, an alkaline earth metal, ammonium, and NR₁R₂R₃R₄ where R₁, R₂, R₃R₄ are independently hydrogen, an alkyl group having from 1 to 7 carbon atoms, or alkoxyl group having from 1 to 7 carbons; and
a dicarboxylate monomer includes a compound represented by structure (II) or (III): 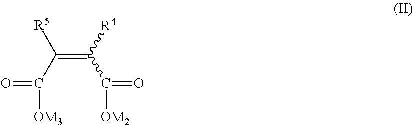 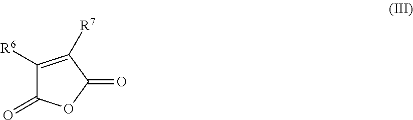
wherein R⁴, R⁵, R⁶ and R⁷ are independently hydrogen, alkyl group containing up to 7 carbon atoms, or hydroxyl group; M₂ and M₃ are independently selected from the group consisting of hydrogen, an alkali metal, an alkaline earth metal, ammonium, and NR₁R₂R₃R₄ where R₁, R₂, R₃ and R₄ are independently hydrogen, an alkyl group having from 1 to 7 carbon atoms, or alkoxyl group having from 1 to 7 carbons.

3. The traceable polymeric scale inhibitor of claim 2, wherein the monocarboxylate monomer includes a monomer selected from the group consisting of acrylic acid, oligomeric acrylic acid, methacrylic acid, crotonic acid, vinylacetic acid and water-soluble salts thereof.

4. The traceable polymeric scale inhibitor of claim 2, wherein the dicarboxylate monomer includes a monomer selected from the group consisting of maleic acid, maleic anhydride, fumaric acid, itaconic acid, citraconic acid, mesaconic acid, cyclohexenedicarboxylic acid, cis-1,2,3,6-tetrahydrophthalic anhydride, 3,6-epoxy-1,2,3,6-tetrahydrophthalic anhydride, and water-soluble salts thereof.

5. The traceable polymeric scale inhibitor of claim 1, comprising: 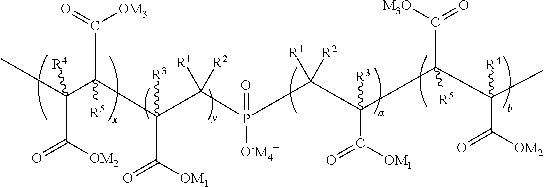
wherein
R¹, R², R³, R⁴ and R⁵ are independently hydrogen, alkyl group containing up to 7 carbon atoms, or NR₁R₂R₃ where R₁, R₂ and R₃ are independently hydrogen, an alkyl group having from 1 to 7 carbon atoms, or alkoxyl group having from 1 to 7 carbons;
M₁, M₂, M₃ and M₄ are independently selected from the group consisting of hydrogen, an alkali metal, an alkaline earth metal, ammonium, and NR₁R₂R₃R₄ where R₁, R₂, R₃ and R₄ are independently hydrogen, an alkyl group having from 1 to 7 carbon atoms, or alkoxyl group having from 1 to 7 carbons;
x and y are independently integral numbers, a sum of x plus y being greater than 2; and
a and b are independently integral numbers; a sum of a plus b being greater than 2.

6. The traceable polymeric scale inhibitor of claim 1, comprising: 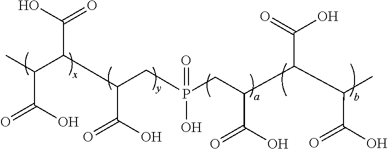
wherein
x and y are independently integral numbers, a sum of x plus y being greater than 2; and
a and b are independently integral numbers, a sum of a plus b being greater than 2

7. The traceable polymeric scale inhibitor of claim 1, comprising:
a traceable phosphinate moiety on a polymer backbone; and
a scale inhibiting moiety comprising carboxylate functionality including a member selected from the group consisting of carboxylic acid, carboxylate salt, and combination thereof.

8. The traceable polymeric scale inhibitor of claim 1, wherein an amount of the traceable phosphinate moiety is from about 0.01% to about 20% weight based on total weight of the traceable polymeric scale inhibitor.

9. The traceable polymeric scale inhibitor of claim 1, wherein an amount of the traceable phosphinate moiety is from about 0.1% to about 2% weight based on total weight of the traceable polymeric scale inhibitor.

10. The traceable polymeric scale inhibitor of claim 1, having a number average molecular weight from about 1000 Daltons to about 15000 Daltons.

11. The traceable polymeric scale inhibitor of claim 1, having an effective minimum inhibitor concentration (MIC) of less than about 50 ppm.

12. The traceable polymeric scale inhibitor of claim 1, having an effective minimum inhibitor concentration (MIC) from about 5 ppm to about 25 ppm.

13. The traceable polymeric scale inhibitor of claim 1, having an effective minimum inhibitor concentration (MIC) from about 7 ppm to about 15 ppm.

14. The traceable polymeric scale inhibitor of claim 1, having a minimum detectable limit of about 0.5 ppm based on dry weight of the traceable polymeric scale inhibitor using Palintest Organophosphonate titration method.

15. A method of reducing scale formation, comprising:
treating fluid subjected to scale formation with a traceable polymeric scale inhibitor, wherein the traceable polymeric scale inhibitor comprises a scale inhibiting moiety and a traceable phosphinate moiety, the scale inhibiting moiety comprising carboxylate functionality.

16. The method of claim 15, wherein the fluid subjected to scale formation includes oilfield fluids.

17. The method of claim 15, wherein treating fluid subjected to scale formation with a traceable polymeric scale inhibitor comprises adding the traceable polymeric scale inhibitor periodically, continually or continuously to produced water or injection water.

18. The method of claim 15, wherein treating fluid subjected to scale formation with a traceable polymeric scale inhibitor comprises applying the traceable polymeric scale inhibitor to subterranean formation by squeeze treatment.

19. The method of claim 15, wherein treating fluid subjected to scale formation with a traceable polymeric scale inhibitor comprises applying the traceable polymeric scale inhibitor to aqueous fluid present in at least one of subterranean formation, surface tubing in fluid communication therewith, and subsurface tubing in fluid communication therewith.

20. The method of claim 15, wherein treating fluid subjected to scale formation with a traceable polymeric scale inhibitor comprises applying the traceable polymeric scale inhibitor to the fluid using a technique selected from the group consisting of gas-lift injection, downhole annulus injection, encapsulation or soluble matrix techniques, sub-sea wellhead injection, secondary topside treatment, and combinations thereof.

21. The method of claim 15, further comprising:
measuring an amount of the traceable polymeric scale inhibitor in the fluid periodically, continually or continuously; and
adding the traceable polymeric scale inhibitor to the fluid when the measured amount of traceable polymeric scale inhibitor is approaching a minimum inhibition concentration of the traceable polymeric scale inhibitor.

22. The method of claim 21, wherein measuring an amount of the traceable polymeric scale inhibitor in the fluid comprises titrating the traceable polymeric scale inhibitor with a color-forming agent.

23. The method of claim 22, wherein titrating the traceable polymeric scale inhibitor with a color-forming agent comprises titrating the traceable polymeric scale inhibitor using Palintest Organophosphonate titration method.

24. The method of claim 15, further comprising:
determining an amount of the traceable phosphinate moiety in the fluid periodically, continually or continuously;
correlating the amount of traceable phosphinate moiety to an amount of the traceable polymeric scale inhibitor in the fluid; and
adjusting the amount of the traceable polymeric scale inhibitor in the fluid to a desired concentration.

25. The method of claim 24, wherein determining an amount of the traceable phosphinate moiety in the fluid comprises titrating the traceable phosphinate moiety using Palintest Organophosphonate titration method.

26. The method of claim 15, wherein the fluid subjected to scale formation includes fluid in a system selected from the group consisting of cooling tower water systems; boiler water systems; hot water heaters; heat exchangers; mineral process waters; paper mill water systems; black liquor evaporators in the pulp industry; desalination systems; cleaning system; pipelines; gas scrubber systems; continuous casting processes in the metallurgical industry; air conditioning and refrigeration systems; industrial and petroleum process water; water reclamation and purification systems; membrane filtration water systems; food processing streams; and waste treatment systems.
